(19) United States
(12) Patent Application Publication
(10) Pub. No.: US 2010/0115300 A1
(43) Pub. Date: May 6, 2010

(54) METHOD AND DEVICE FOR ADJUSTING CLOCK FREQUENCY AND OPERATING VOLTAGE OF COMPUTER SYSTEM

(75) Inventors: Chao-Chung Wu, Taipei (TW); Chien-Shien Lin, Taipei (TW); Yu-Chen Lee, Taipei (TW)

Correspondence Address: KIRTON AND MCCONKIE, 60 EAST SOUTH TEMPLE,, SUITE 1800, SALT LAKE CITY, UT, 84111, US

(73) Assignee: ASUSTeK COMPUTER INC., Taipei (TW)

(21) Appl. No.: 12/611,475

(22) Filed: Nov. 3, 2009

(30) Foreign Application Priority Data
Nov. 5, 2008 (TW) 097142695

(51) Int. Cl. G06F 1/04; G06F 1/00

(52) U.S. Cl. 713/300; 713/500

(57) ABSTRACT

A frequency and voltage adjusting method is provided for adjusting a clock frequency or an operating voltage of a first component of a computer system. Firstly, a control function of a computer keyboard is enabled. Then, an initiating signal is generated by the computer keyboard. After the initiating signal is received, a control key of the computer keyboard is depressed to generate a frequency-increasing signal, a frequency-decreasing signal, a voltage-increasing signal or a voltage-decreasing signal. The clock frequency is increased according to the frequency-increasing signal. The clock frequency is decreased according to the frequency-decreasing signal. The operating voltage is increased according to the voltage-increasing signal. The operating voltage is decreased according to the voltage-decreasing signal.

### FIELD OF THE INVENTION

The present invention relates to a computer system, and more particularly to a computer system having a function of adjusting the clock frequency and the operating voltage. The present invention also relates to a method for adjusting the clock frequency and the operating voltage of a computer system.

### BACKGROUND OF THE INVENTION

For enhancing the performance of a computer system, the user may change the BIOS (basic input output system) settings of the computer system. For example, through the BIOS settings, the operating voltage or the clock frequency of a motherboard is adjustable. As known, overclocking is the process of forcing a computer component to run at a higher clock rate than it was designed or designated by the manufacturer; and a dynamic voltage scaling process to increase voltage is known as overvoltage.

That is, through the BIOS settings, the operating voltage or the clock frequency of a specified component on the motherboard is adjustable. The specified component includes for example a central processing unit (CPU), a front side bus (FSB) or a memory. After operating voltages and clock frequencies of these specified components are set via the BIOS setup menu, the set parameters should be stored in the BIOS. Until the computer system is reset, the set parameters are loaded into the BIOS to implement the overvoltage or overclocking processes. According to the set parameters, the clock generator or the voltage regulator of the computer system is correspondingly controlled, so that these specified components could be operated at the desired operating voltages or clock frequencies.

For achieving the optimal performance of the computer system, the parameters are continuously changed through the BIOS settings and then the computer system is re-started until desired parameters are obtained. As known, the process of changing the BIOS settings is very time-consuming and inefficient.

For facilitating the user to adjust the operating voltage or the clock frequency, the motherboard manufacturer usually provides a frequency and voltage adjusting program. When the frequency and voltage adjusting program is executed under the operating system, the operating voltage or the clock frequency of a specified component could be adjusted. By executing the frequency and voltage adjusting program to adjust the parameters according to the practical requirements, the computer system does not need to be reset.

Generally, the performance of the computer system is deteriorated during the frequency and voltage adjusting program is executed. In addition, the user fails to realize whether the parameters obtained by executing the frequency and voltage adjusting program are sufficient to achieve the optimal performance of the computer system. For realizing the performance of the computer system, benchmark software needs be executed after the parameters are obtained.

Moreover, in order to prevent adverse influence on the performance of the computer, the frequency and voltage adjusting program needs to be disabled while the benchmark software is executed. If the performance is not satisfied, the frequency and voltage adjusting program and the benchmark software will be successively executed in order to achieve the optimal performance of the computer system.

Recently, a frequency and voltage adjusting device is mounted on a motherboard of the computer system. By controlling the frequency and voltage adjusting device, the power user could quickly and arbitrarily adjust the operating voltage or the clock frequency of a specified component without deteriorating the performance of the computer system.

FIG. 1 is a schematic functional block diagram illustrating a motherboard having a frequency and voltage adjusting device according to the prior art. The frequency and voltage adjusting device is used for adjusting the operating voltage or the clock frequency of a specified component on a motherboard. The specified component includes for example a central processing unit (CPU), a front side bus (FSB) or a memory.

As shown in FIG. 1, a central processing unit (CPU) 110, a north bridge (NB) chip 120, a south bridge (SB) chip 130, a memory 140, a graphic processing unit (GPU) 150 and a basic input output system (BIOS) 132 are mounted on the motherboard 100. The north bridge chip 120 is connected with the CPU 110, the south bridge chip 130, the memory 140 and the GPU 150. The BIOS 132 is connected with the south bridge chip 130. A clock generator 160 is also disposed on the motherboard 100 for generating various clock signals such as front side bus (FSB) clock signals, north bridge (NB) clock signals or the like. For example, the FSB clock signals are transmitted to the CPU 110, and the NB clock signals are transmitted to the north bridge chip 120. A voltage regulator 190 is also disposed on the motherboard 100 for providing various operating voltages such as CPU core voltage (Vcore) to the CPU 110.

For clarification and brevity, only the clock frequency of the FSB clock signal and the CPU core voltage (Vcore) are illustrated in FIG. 1. It is noted that, however, those skilled in the art will readily observe that the operating voltages and clock frequencies of other components on the motherboard 100 could be adjusted by the frequency and voltage adjusting device as shown in FIG. 1.

The frequency and voltage adjusting device comprises an adjustable unit 170, a control circuit 180 and a display unit 176. The control circuit 180 is connected with a standby voltage source (not shown) of the computer system. In addition, the control circuit 180 is connected with the clock generator 160, the voltage regulator 190 and the south bridge chip 130 via a system management bus (SM bus). The control circuit 180 is also connected with the adjustable unit 170 and the display unit 176.

The control circuit 180 comprises a signal processing unit 182 and a display processing unit 184. The adjustable unit 170 comprises a joystick 172, which is fixed on the motherboard 100. An example of the display unit 176 is a small scale display device.

When the adjustable unit 170 is controlled by the user, a frequency-increasing signal or a frequency-decreasing signal is transmitted to the signal processing unit 182 of the control circuit 180. According to the frequency-increasing signal or the frequency-decreasing signal, the signal processing unit 182 will control the clock generator 160 to change the clock frequency by an increment Δf1 or a decrement Δf2. For example, when the joystick 172 of the adjustable unit 170 is once turned to the right, the clock frequency is increased by one increment Δf1. Whereas, when the joystick 172 of the adjustable unit 170 is once turned to the left, the clock frequency is decreased by one decrement Δf2. In an example, the frequency of the FSB clock signal of the computer system is 266 MHz, the frequency increment Δf1 is 3.3 MHz, and the frequency decrement Δf2 is 3.3 MHz. If the clock frequency is continuously increased by ten increments, the frequency of the FSB clock signal is adjusted to be 300 MHz (i.e. 266+10×(3.3)=300). If the clock frequency is continuously decreased by ten decrements again, the frequency of the FSB clock signal is adjusted to be 266 MHz (i.e. 300−10×(3.3)=266).

Similarly, when the adjustable unit 170 is controlled by the user, a voltage-increasing signal or a voltage-decreasing signal is transmitted to the signal processing unit 182 of the control circuit 180. According to the voltage-increasing signal or the voltage-decreasing signal, the signal processing unit 182 will control the voltage regulator 190 to change the CPU core voltage (Vcore) by an increment ΔV1 or a decrement ΔV2.

After the clock frequency of the FSB clock signal or the CPU core voltage (Vcore) has been changed by the control circuit 180, the parameters associated with the clock frequency of the FSB clock signal or the CPU core voltage (Vcore) will be refreshed and then stored in the BIOS 132 through the south bridge chip 130. At the same time, the clock frequency of the FSB clock signal or the CPU core voltage (Vcore) will be processed by the display processing unit 184 of the control circuit 180 and then shown on the display unit 176. In other words, the clock frequency of the FSB clock signal and the CPU core voltage (Vcore) could be realized via the display unit 176 without deteriorating the performance of the computer system.

When the benchmark software is executed in the computer system, the frequency-increasing signal, the frequency-decreasing signal, the voltage-increasing signal or the voltage-decreasing signal is generated by controlling the adjustable unit 170. According to the performance result of the computer system, the benchmark software is executed to achieve the optimal performance of the computer system.

The frequency and voltage adjusting device, however, still has some drawbacks. For example, the joystick 172 of the adjustable unit 170 is fixed on the motherboard 100. Generally, the motherboard 100 is installed within the computer case of the computer system after the parameters associated with the clock frequency or operating voltage are determined. In a case that the user intends to adjust the clock frequency or operating voltage, the computer case needs to be disassembled. The process of disassembling the computer case is very troublesome.

### SUMMARY OF THE INVENTION

In accordance with an aspect of the present invention, there is provided a frequency and voltage adjusting method for adjusting a clock frequency or an operating voltage of a first component of a computer system. Firstly, a control function of a computer keyboard is enabled. Then, an initiating signal is generated by the computer keyboard. After the initiating signal is received, a control key of the computer keyboard is depressed to generate a frequency-increasing signal, a frequency-decreasing signal, a voltage-increasing signal or a voltage-decreasing signal. The clock frequency is increased according to the frequency-increasing signal. The clock frequency is decreased according to the frequency-decreasing signal. The operating voltage is increased according to the voltage-increasing signal. The operating voltage is decreased according to the voltage-decreasing signal.

In accordance with another aspect of the present invention, there is provided a computer system having frequency and voltage adjusting functions. The computer system includes a motherboard, a control circuit and a computer keyboard. The motherboard includes a first component, a clock generator and a voltage regulator. The clock generator generates a clock frequency to the first component. The voltage regulator outputs an operating voltage to the first component. The control circuit is connected with the clock generator and the voltage regulator. The computer keyboard is connected with the control circuit for generating a frequency-increasing signal, a frequency-decreasing signal, a voltage-increasing signal or a voltage-decreasing signal. Under control of the control circuit, the clock frequency generated by the clock generator is adjusted according to the frequency-increasing signal or the frequency-decreasing signal, and the operating voltage outputted by the voltage regulator is adjusted according to the voltage-increasing signal or the voltage-decreasing signal.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a schematic functional block diagram illustrating a motherboard having a frequency and voltage adjusting device according to the prior art;

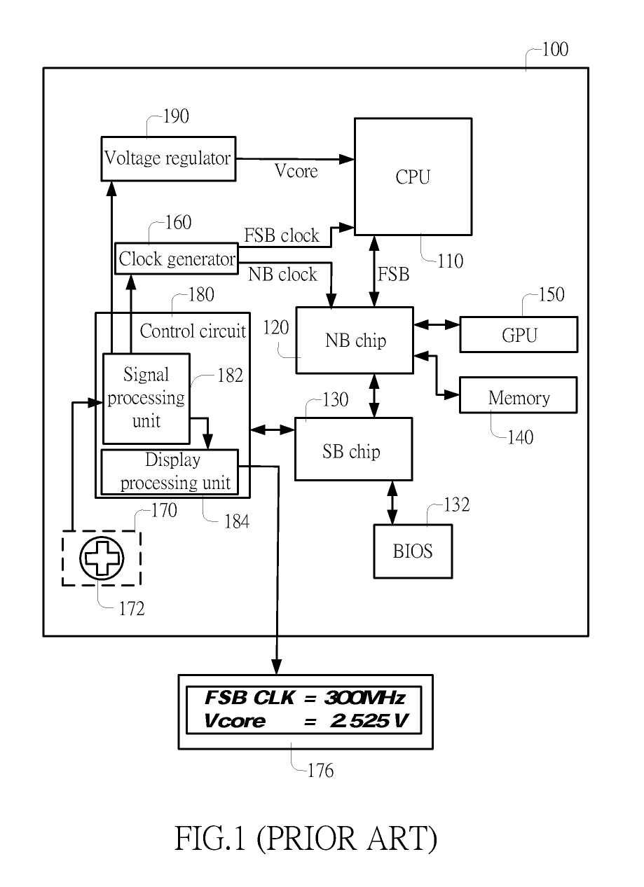

FIG. 2 is a schematic functional block diagram illustrating a computer system having frequency and voltage adjusting functions according to a first embodiment of the present invention; and

FIG. 3 is a schematic functional block diagram illustrating a computer system having frequency and voltage adjusting functions according to a second embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

The present invention provides a method and a device for adjusting the clock frequency or operating voltage of a specified component without the need of disassembling the computer case.

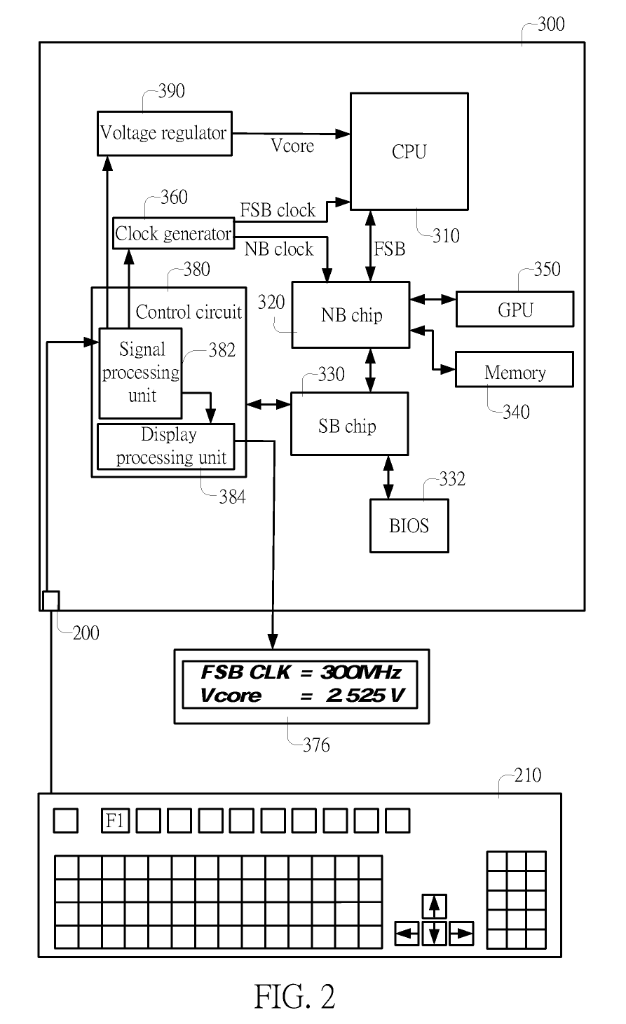

FIG. 2 is a schematic functional block diagram illustrating a computer system having frequency and voltage adjusting functions according to a first embodiment of the present invention. In the computer system of FIG. 2, a clock frequency and an operating voltage of a specified component are adjustable. An example of the specified component includes but is not limited to a CPU, a front side bus (FSB) or a memory.

As shown in FIG. 2, a central processing unit (CPU) 310, a north bridge (NB) chip 320, a south bridge (SB) chip 330, a memory 340, a graphic processing unit (GPU) 350 and a basic input output system (BIOS) 332 are mounted on the motherboard 300. The north bridge chip 320 and the south bridge chip 330 are collectively referred as a chipset. The north bridge chip 320 is connected with the CPU 310, the south bridge chip 330, the memory 340 and the GPU 350. The BIOS 332 is connected with the south bridge chip 330. A clock generator 360 is also disposed on the motherboard 300 for generating various clock signals such as front side bus (FSB) clock signals, north bridge (NB) clock signals or the like. For example, the FSB clock signals are transmitted to the CPU 310, and the NB clock signals are transmitted to the north bridge chip 320. A voltage regulator 390 is also disposed on the motherboard 300 for providing different operating voltages such as CPU core voltage (Vcore) to the CPU 310.

For clarification and brevity, only the clock frequency of the FSB clock signal and the CPU core voltage (Vcore) are illustrated in FIG. 2. It is noted that, however, those skilled in the art will readily observe that the operating voltages and clock frequencies of other components on the motherboard 300 could be adjusted by the frequency and voltage adjusting device as shown in FIG. 2.

In this embodiment, a control circuit 380 is connected with a keyboard 210 through a connecting port 200. An example of the connecting port 200 includes but is not limited to a universal serial bus (USB) port or a PS/2 connector. In addition, the control circuit 380 is connected with the clock generator 360, the voltage regulator 390 and the south bridge chip 330 via a system management bus (SM bus). The control circuit 380 comprises a signal processing unit 382 and a display processing unit 384. The signal processing unit 382 is connected with the keyboard 210. The display processing unit 384 is connected with a display unit 376. An example of the display unit 376 is a small scale display device.

For adjusting the clock frequency or operating voltage during normal operations of the computer system, the BIOS 332 should be set to enable the adjusting function so that the keyboard 210 could be used to adjust the clock frequency or operating voltage.

Before the enabling action, the function of using the keyboard 210 to adjust the clock frequency or operating voltage is disabled. That is, when the computer system is introduced to the market, the user fails to adjust the clock frequency or operating voltage by using the keyboard 210 without setting the BIOS 332. During normal operations of the computer system, a key signal is transmitted from the signal processing unit 382 of the control circuit 380 to the south bridge chip 330 in response to any key-press of the keyboard 210, operated as the conventional keyboard.

For using the keyboard 210 to adjust the clock frequency or operating voltage, the computer system is booted and then the control function of using the keyboard 210 to adjust the clock frequency or operating voltage is enabled through the BIOS 332.

For preventing from erroneous operations, an initiating signal is generated by the keyboard 210 when a specific key (e.g. the F1 function key) has been depressed for a certain period (e.g. over 3 seconds). After the initiating signal is received by the signal processing unit 382 of the control circuit 380, the user could operate the direction key (i.e. the left/right/up/down keys) to generate a frequency-increasing signal, a frequency-decreasing signal, a voltage-increasing signal or a voltage-decreasing signal.

In other words, after the initiating signal is received by the signal processing unit 382 of the control circuit 380 and the direction key is depressed by the user, the signal processing unit 382 will not generate a corresponding key signal to the south bridge chip 330. When the direction key is once depressed, the signal processing unit 382 will control the clock generator 360 to change the clock frequency by an increment Δf1 or a decrement Δf2. Similarly, when the direction key is once depressed, the signal processing unit 382 will control the voltage regulator 390 to change the CPU core voltage (Vcore) by an increment ΔV1 or a decrement ΔV2.

Moreover, after the clock frequency of the FSB clock signal or the CPU core voltage (Vcore) has been changed by the control circuit 380, the parameters associated with the clock frequency of the FSB clock signal or the CPU core voltage (Vcore) will be refreshed and then stored in the BIOS 332 through the south bridge chip 330. At the same time, the clock frequency of the FSB clock signal or the CPU core voltage (Vcore) will be processed by the display processing unit 384 of the control circuit 380 and then shown on the display unit 376. In other words, the clock frequency of the FSB clock signal and the CPU core voltage (Vcore) could be realized via the display unit 376 without deteriorating the performance of the computer system.

From the description in the first embodiment, the clock frequency or operating voltage is adjusted by using the computer keyboard of the computer system without the need of disassembling the computer case.

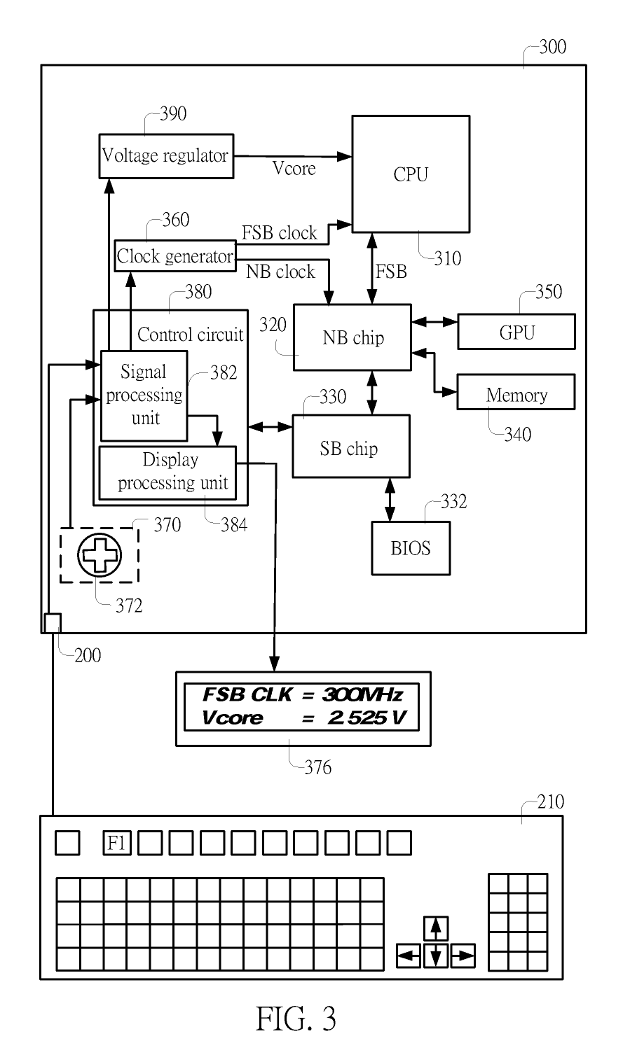

FIG. 3 is a schematic functional block diagram illustrating a computer system having frequency and voltage adjusting functions according to a second embodiment of the present invention. In the computer system of FIG. 3, a clock frequency and an operating voltage of a specified component are adjustable. An example of the specified component includes but is not limited to a CPU, a front side bus (FSB) or a memory.

As shown in FIG. 3, a central processing unit (CPU) 310, a north bridge (NB) chip 320, a south bridge (SB) chip 330, a memory 340, a graphic processing unit (GPU) 350 and a basic input output system (BIOS) 332 are mounted on the motherboard 300. The north bridge chip 320 is connected with the CPU 310, the south bridge chip 330, the memory 340 and the GPU 350. The BIOS 332 is connected with the south bridge chip 330. A clock generator 360 is also disposed on the motherboard 300 for generating various clock signals such as front side bus (FSB) clock signals, north bridge (NB) clock signals or the like. For example, the FSB clock signals are transmitted to the CPU 310, and the NB clock signals are transmitted to the north bridge chip 320. A voltage regulator 390 is also disposed on the motherboard 300 for providing various operating voltages such as CPU core voltage (Vcore) to the CPU 310.

For clarification and brevity, only the clock frequency of the FSB clock signal and the CPU core voltage (Vcore) are illustrated in FIG. 3. It is noted that, however, those skilled in the art will readily observe that the operating voltages and clock frequencies of other components on the motherboard 300 could be adjusted by the frequency and voltage adjusting device as shown in FIG. 3.

In this embodiment, a control circuit 380 is connected with a keyboard 210 through a connecting port 200. An example of the connecting port 200 includes but is not limited to a universal serial bus (USB) port or a PS/2 connector. In addition, the control circuit 380 is connected with the clock generator 360, the voltage regulator 390 and the south bridge chip 330 via a system management bus (SM bus). The control circuit 380 comprises a signal processing unit 382 and a display processing unit 384. The signal processing unit 382 is connected with the keyboard 210 and an adjustable unit 370. The display processing unit 384 is connected with a display unit 376. An example of the display unit 376 is a small scale display device. The adjustable unit 370 comprises a joystick 372, which is fixed on the motherboard 300.

The function of using the keyboard 210 to adjust the clock frequency or operating voltage is disabled before the enabling action through the BIOS 332. That is, when the computer system is introduced to the market, the user fails to adjust the clock frequency or operating voltage by using the keyboard 210. During normal operations of the computer system, a key signal is transmitted from the signal processing unit 382 of the control circuit 380 to the south bridge chip 330 in response to any key-press of the keyboard 210.

Before the enabling action, the adjustable unit 370 could be controlled by the user to transmit a frequency-increasing signal or a frequency-decreasing signal to the signal processing unit 382 of the control circuit 380. According to the frequency-increasing signal or the frequency-decreasing signal, the signal processing unit 382 will control the clock generator 360 to change the clock frequency by an increment Δf1 or a decrement Δf2. Similarly, the adjustable unit 370 could be controlled by the user to transmit a voltage-increasing signal or a voltage-decreasing signal to the signal processing unit 382 of the control circuit 380. According to the voltage-increasing signal or the voltage-decreasing signal, the signal processing unit 382 will control the voltage regulator 390 to change the CPU core voltage (Vcore) by an increment ΔV1 or a decrement ΔV2.

For using the keyboard 210 to adjust the clock frequency or operating voltage, the control function of using the keyboard 210 to adjust the clock frequency or operating voltage should be enabled through the BIOS 332 during the booting of the computer system.

For preventing from erroneous operations, an initiating signal is generated by the keyboard 210 when a specific key (e.g. the function key “F1”) has been depressed for a certain period (e.g. over 3 seconds). After the initiating signal is received by the signal processing unit 382 of the control circuit 380, the user could operate the direction key (i.e. the left/right/up/down keys) to generate a frequency-increasing signal, a frequency-decreasing signal, a voltage-increasing signal or a voltage-decreasing signal.

In other words, after the initiating signal is received by the signal processing unit 382 of the control circuit 380 and the direction key is depressed by the user, the signal processing unit 382 will not generate a corresponding key signal to the south bridge chip 330. When the direction key is once depressed, the signal processing unit 382 will control the clock generator 360 to change the clock frequency by an increment Δf1 or a decrement Δf2. Similarly, when the direction key is once depressed, the signal processing unit 382 will control the voltage regulator 390 to change the CPU core voltage (Vcore) by an increment ΔV1 or a decrement ΔV2.

Moreover, after the clock frequency of the FSB clock signal or the CPU core voltage (Vcore) has been changed by the control circuit 380, the parameters associated with the clock frequency of the FSB clock signal or the CPU core voltage (Vcore) will be refreshed and then stored in the BIOS 332 through the south bridge chip 330. At the same time, the clock frequency of the FSB clock signal or the CPU core voltage (Vcore) will be processed by the display processing unit 384 of the control circuit 380 and then shown on the display unit 376. In other words, the clock frequency of the FSB clock signal and the CPU core voltage (Vcore) could be realized via the display unit 376 without deteriorating the performance of the computer system.

From the description in the second embodiment, the clock frequency or operating voltage could be adjusted by using the adjustable unit 370 after the computer case is disassembled. Alternatively, the clock frequency or operating voltage could be also adjusted by using the computer keyboard 210 of the computer system without the need of disassembling the computer case.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A frequency and voltage adjusting method for adjusting a clock frequency or an operating voltage of a first component of a computer system, the frequency and voltage adjusting method comprising steps of:
enabling a control function of a computer keyboard;
generating an initiating signal by the computer keyboard; and
depressing a control key of the computer keyboard after the initiating signal is received, thereby generating a frequency-increasing signal, a frequency-decreasing signal, a voltage-increasing signal or a voltage-decreasing signal, wherein the clock frequency is increased according to the frequency-increasing signal, the clock frequency is decreased according to the frequency-decreasing signal, the operating voltage is increased according to the voltage-increasing signal, and the operating voltage is decreased according to the voltage-decreasing signal.

2. The frequency and voltage adjusting method according to claim 1, further comprising a step of entering a basic input output system before the step of enabling the control function of the computer keyboard.

3. The frequency and voltage adjusting method according to claim 1 wherein after the frequency-increasing signal, the frequency-decreasing signal, the voltage-increasing signal or the voltage-decreasing signal is generated by depressing the control key of the computer keyboard, the clock frequency or the operating voltage is refreshed and stored in a basic input output system.

4. The frequency and voltage adjusting method according to claim 1 wherein the first component includes a central processing unit, a chipset, a front side bus or a memory.

5. The frequency and voltage adjusting method according to claim 1 wherein the initiating signal is generated when a specified key of the computer keyboard is depressed for a first time period.

6. The frequency and voltage adjusting method according to claim 1 wherein the control key of the computer keyboard includes an up key, a down key, a left key or a right key, which is depressed to respectively generate the frequency-increasing signal, the frequency-decreasing signal, the voltage-increasing signal or the voltage-decreasing signal.

7. The frequency and voltage adjusting method according to claim 1, further comprising a step of displaying the clock frequency or the operating voltage after the control key is depressed to generate the frequency-increasing signal, the frequency-decreasing signal, the voltage-increasing signal or the voltage-decreasing signal.

8. A computer system having frequency and voltage adjusting functions, the computer system comprising:
a motherboard comprising a first component, a clock generator and a voltage regulator, wherein the clock generator generates a clock frequency to the first component, and the voltage regulator outputs an operating voltage to the first component;
a control circuit connected with the clock generator and the voltage regulator; and
a computer keyboard connected with the control circuit for generating a frequency-increasing signal, a frequency-decreasing signal, a voltage-increasing signal or a voltage-decreasing signal, wherein under control of the control circuit, the clock frequency generated by the clock generator is adjusted according to the frequency-increasing signal or the frequency-decreasing signal, and the operating voltage outputted by the voltage regulator is adjusted according to the voltage-increasing signal or the voltage-decreasing signal.

9. The computer system according to claim 8, further comprising a display unit connected with the control circuit for displaying the clock frequency or the operating voltage.

10. The computer system according to claim 9 wherein the control circuit comprises:
a signal processing unit for receiving the frequency-increasing signal, the frequency-decreasing signal, the voltage-increasing signal or the voltage-decreasing signal, thereby controlling the clock generator or the voltage regulator; and
a display processing unit connected with the display unit and the signal processing unit.

11. The computer system according to claim 8, further comprising an adjustable unit, which is mounted on the motherboard and connected to the control unit for generating the frequency-increasing signal, the frequency-decreasing signal, the voltage-increasing signal or the voltage-decreasing signal.

12. The computer system according to claim 8 wherein the clock frequency and the operating voltage are refreshed by the control circuit and stored in a basic input output system of the motherboard.

13. The computer system according to claim 8 wherein the first component includes a central processing unit, a chipset, a front side bus or a memory.
